(19) United States
(12) Patent Application Publication
(10) Pub. No.: US 2020/0381932 A1
(43) Pub. Date: Dec. 3, 2020

(54) DEVICE AND METHOD FOR DISPLAYING BATTERY STATE

(71) Applicants: Inventec (Pudong) Technology Corporation, Shanghai (CN); INVENTEC CORPORATION, Taipei (TW)

(72) Inventors: Chun-Chi LIN, Taipei (TW); Ying-Shan CHEN, Taipei (TW); Tong-Ting WEI, Taipei (TW)

(21) Appl. No.: 16/539,174

(22) Filed: Aug. 13, 2019

(30) Foreign Application Priority Data
May 29, 2019 (CN) 201910457930.2

(51) Int. Cl. H02J 7/00; H05B 37/02

(52) U.S. Cl. CPC H02J 7/0047; H05B 37/0209

(57) ABSTRACT

A method for displaying battery state comprises the following steps. A battery assembly transmits a battery data to a controller to determine a health state of the battery assembly when a CPU is not in operation. When the health state is an abnormal state, the light-emitting assembly is controlled to generate light having first optical characteristic. When the healthy state is in a normal state, the controller determines whether it's in a triggering period after receiving a trigger signal, and generates a power value according to the battery data. When the controller is in the triggering period, controls the light-emitting assembly to perform the current power display program according to the power value. Conversely, the controller determines whether the battery assembly receives an external power. When the battery assembly receives the external power, the light-emitting assembly is controlled to perform a charging state display program according to the power value.

### CROSS-REFERENCE TO RELATED APPLICATIONS

This non-provisional application claims priority under 35 U.S.C. § 119(a) on Patent Application No(s). 201910457930.2 filed in China on 29th, May, 2019, the entire contents of which are hereby incorporated by reference.

### BACKGROUND

### 1. Technical Field

The disclosure relates to a method for displaying battery state, more particularly to the method for displaying the battery state of an electronic device even when the central processing unit of the electronic device is not in operation.

### 2. Related Art

Nowadays, the laptop has become a popular electronic product. Generally, the battery of the laptop is configured to a rechargeable battery, and the information such as the remained power, the charging time, etc., which are shown on the screen when the laptop is operating in the operation system (OS).

However, when the laptop has not entered the OS, the user can not directly get the information about the battery, and it is not convenient once the user needs to take the laptop out suddenly. Similarly, when the laptop is not in the OS and is charged currently, the user can not directly get the state of charge. Hence, the probability of the overcharge of the battery is much higher, and the battery may be damaged due to the overcharge. Additionally, it needs to enter particular command in the specific interface to get the health state of the battery for most of the laptops, and aforementioned way is not institutive for the common users.

### SUMMARY

According to one or more embodiment of this disclosure, a method for displaying battery state adapted to an electronic device having a CPU, which comprises the following steps. A battery assembly transmits a battery data to a controller to determine a health state of the battery assembly when the CPU is not in operation. When the health state is in an abnormal state, the light-emitting assembly is controlled to generate light having the first optical characteristic. When the healthy state is in a normal state, the controller determines whether is in a triggering period after receiving a trigger signal, and generates a power value according to the battery data. When the controller is in the triggering period, controls the light-emitting assembly to perform the current power display program according to the power value. Conversely, the controller determines whether the battery assembly receives an external power. When the battery assembly receives the external power, the light-emitting assembly is controlled to perform a charging state display program according to the power value.

According to one or more embodiment of this disclosure, a device for displaying battery state adapted to an electronic device having a central processing unit, which comprises a battery assembly, a light-emitting assembly and a controller. The battery assembly generating battery data when the central processing unit is not in operation. The light-emitting assembly is adapted to generate a light having a first optical characteristic in a trigger period, and performs a current power display program when the battery assembly receives an external power. The controller is electrically connected between the battery assembly and the light-emitting assembly, with the controller receives the battery data and determines a health state of the battery assembly according to the battery data, wherein the controller controls the light-emitting assembly to generate light having the first optical characteristic when the controller determines that the health state is in an abnormal state. Furthermore, the controller determines whether the controller is in a trigger period following a trigger signal received by the controller when the controller determines that the health state is in a normal state, and the controller generates the battery power value according to the battery data, wherein the controller controls the light-emitting assembly to perform the current power display program according to the battery power value in the trigger period. Additionally, the controller determines whether the battery assembly receives the external power when the controller is outside the trigger period, wherein the controller controls the light-emitting assembly to perform a charging state display program according to the battery power value when the controller the battery assembly receives the external power.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is the block diagram of the device for displaying battery state in an embodiment of this disclosure.

FIG. 1B is the schematic diagram of the device for displaying battery state in an embodiment of this disclosure.

FIG. 2A is the block diagram of the device for displaying battery state in another embodiment of this disclosure.

FIGS. 2B and 2C are the schematic diagrams of the light-emitting assembly of the device for displaying battery state in another embodiment of this disclosure.

FIG. 3 is the flowchart of the method for displaying battery state in an embodiment of this disclosure.

FIG. 4A is the detailed flowchart of the method for displaying battery state in an embodiment of this disclosure.

FIG. 4B is the detailed flowchart of the method for displaying battery state in an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

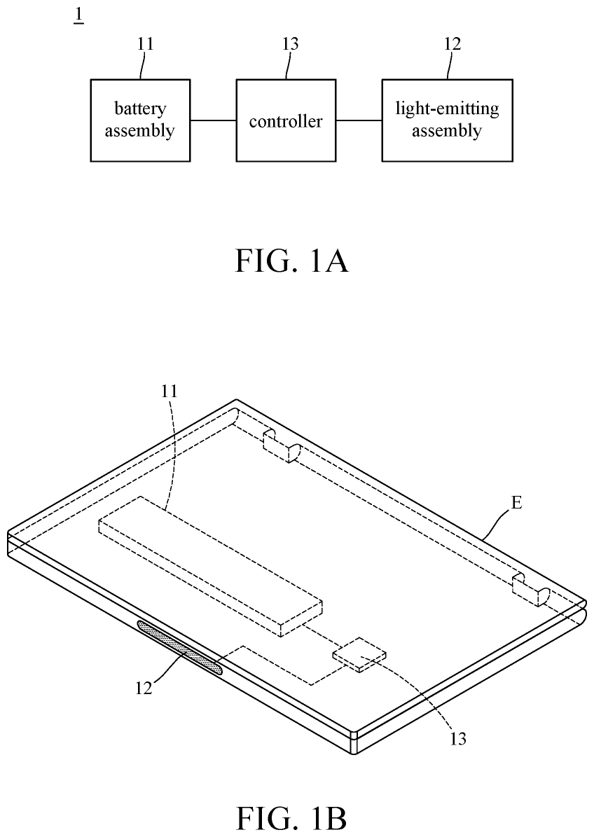

Please refer to FIG. 1A and FIG. 1B. FIG. 1A is the block diagram of the device for displaying battery state in an embodiment of this disclosure. FIG. 1B is the schematic diagram of the device for displaying battery state shown in FIG. 1A. The device for displaying battery state 1 is adapted to an electronic device E having a central processing unit (CPU), such as the laptop. The battery state wireless displaying device 1 comprises a battery assembly 11, a light-emitting assembly 12 and a controller 13.

The battery assembly 11 is electrically connected to the controller 13, and the battery assembly 11 generates battery data when the CPU of the electronic device E is not in operation. Specifically, the battery assembly 11 comprises a battery and an integrated circuit (IC) which are electrically connected to each other, wherein the integrated circuit obtains the battery data from the battery, and the integrated circuit sends the battery data to the controller 13. For example, the integrated circuit may be a power management integrated circuit (PMIC), and the battery may be the rechargeable (or the secondary battery) battery such as the lead acid battery, the nickel hydrogen battery or the lithium ion battery, this disclosure is not limited thereto.

On the other hand, aforementioned “the CPU not operating” means the operating system (OS) of the electronic device E is not active, which indicates that the system power states (S-States) is in one of S1 (sleep state) through S5 (soft off state).

The light-emitting assembly 12 is electrically connected to the controller 13, and the light-emitting assembly 12 performs a current power display program or a charging state display program according to an instruction sent from the controller 13. Particularly, the current power display program is performed for displaying current battery power of the battery assembly 11, and the charging state display program is performed for displaying current state of charge when the battery assembly 11 is charging. The light-emitting assembly 12 is able to show the current battery power of the battery assembly 11 or state of charge of the battery assembly 11 by generating light with different optical characteristics. For example, the light-emitting assembly 12 is able to show the current battery power or the state of charge of the battery assembly 11 through the light with different flashing frequencies or different colors. In practice, the light-emitting assembly 12 may comprise a microcontroller unit (MCU) and a lamp, wherein the lamp may be a light-emitting diode (LED), an organic light-emitting diode (OLED) etc., and this disclosure is not limited thereto.

In an embodiment, the light-emitting assembly 12 is disposed on a surface of the electronic device E, and the surface is exposed when a screen of the electronic device E is concealed. For example, when the electronic device E is a laptop, the light-emitting assembly 12 may be disposed on a side surface of the laptop, and the side surface will not be covered as the screen of the laptop is concealed by the bottom part thereof (as shown in FIG. 1B). Hence, the light-emitting assembly 12 is able to show the current battery power or the state of charge display of the battery assembly 11 to the user even when the screen is concealed, thereby the user is able to check the information about the battery assembly 11 quickly and precisely. On the other hand, the battery state displaying device 1 is also able to be disposed on other kinds of electric devices having the secondary batteries, such as a tablet or a mobile phone. Particularly, the screen is on a surface of the tablet/mobile phone, and the battery state displaying device 1 can be disposed on a surface back to the screen. Alternatively, the battery state displaying device 1 can be disposed on a side surface between the front surface, and the rear surface, wherein the front surface is the surface where the screen disposed on, and the rear surface is back to the front surface. As a result, when the screen of the tablet/mobile phone is concealed, the battery state displaying device 1 is able to be exposed directly, thereby the user is able to check the information about the battery assembly 11 intuitively.

The controller 13 is electrically connected between the battery assembly 11 and the light-emitting assembly 12, and the controller 13 receives the battery data from the battery assembly 11. Moreover, the controller 13 determines a health state of the battery assembly 11 according to the battery data, and the controller 13 generates a battery power value according to the battery data; wherein when the health state of the battery assembly 11 is in the abnormal state, the light-emitting assembly 12 generates light having a first optical characteristic (such as red light with higher flashing frequency). Furthermore, the controller 13 determines whether the controller 13 controls the light-emitting assembly 12 to perform the current power display program based on whether the controller 13 is in a trigger period following a trigger signal received by the controller 13, and the controller 13 determines whether the controller 13 controls the light-emitting assembly 12 to perform the charging state display program based on whether the battery assembly 11 receives an external power. When the light-emitting assembly 12 performs the current power display program and the charging state display program, the light-emitting assembly 12 is able to classify different ranges of the battery power value through light with a second optical characteristic (such as breath light with red color) and light with a third optical characteristic (such as breath light with yellow color). Specifically, the battery data may comprise the information of the battery assembly 11, such as original battery capacity, times of charging, current battery power, current voltage and charging electric current. Additionally, the battery information may comprise the current information of the battery assembly 11, such as the state of charges/discharges or the remaining battery power, etc. In practice, the controller 13 may be implemented by an embedded the controller 13 (EC), and the controller 13 is able to receive the battery data as the battery of the battery assembly 11 is keeping to be electrically connected to the controller 13.

Please continue to refer to FIG. 1B for descripting the charging state display program. When the battery assembly 11 receives the external power, the controller 13 is able to further control the light-emitting assembly 12 to generate light having different optical characteristics by determining that the battery power value is in a first range or a second range. When the controller 13 determines that the battery power value is in the first range, the controller 13 controls the light-emitting assembly 12 to generate the light having the second optical characteristic. On the other hand, when the controller 13 determines the battery power value in the first range, the controller 13 controls the light-emitting assembly 12 to generate the light having the third optical characteristic. In an embodiment, the second optical characteristic and the third optical characteristic have different colors, wherein the different colors indicate the colors in different color systems or different brightness or darkness levels, this disclosure is not limited thereto.

For example, the battery power value may be classified into the first range, the second range and a third range. The first range may indicate low battery power (for example, from 0% to 20%), and the light-emitting assembly 12 generates red light (the second optical characteristic). On the other hand, the first range may indicate normal battery power (for example, from 20% to 80%), and the light-emitting assembly 12 may generate yellow light (the third optical characteristic). Also, the third range may indicate high battery power (for example, from 80% to 100%), and the light-emitting assembly 12 may generate green light (the optical characteristic different from the second optical characteristic and the third optical characteristic). It needs to notice that, this disclosure can be implemented by only two different ranges of the battery power, and aforementioned example is just for describing the features more clearly rather than limiting this disclosure.

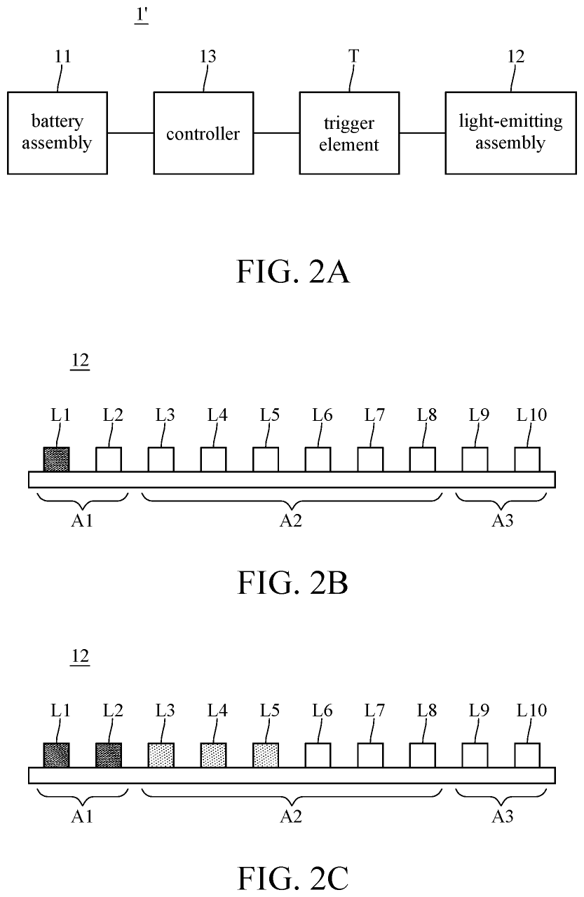

Please refer to FIG. 2A. FIG. 2A is the block diagram of the device for displaying battery state in another embodiment of this disclosure. A battery state displaying device 1′ further comprises a trigger element T electrically connected between the light-emitting assembly 12 and the controller 13. Particularly, the trigger element T is able to send the trigger signal to the controller 13 when the trigger element T is triggered, and the controller 13 controls the light-emitting assembly 12 to perform the current power display program in the trigger period flowing the trigger signal received by the controller 13.

Please refer to FIG. 2B and FIG. 2C for describing the current power display program. FIG. 2B and FIG. 2C are the schematic diagrams of the light-emitting assembly 12 of the battery state displaying device shown in FIG. 2A. In order to describe the features more clearly, as the light-emitting assembly 12 shown in FIG. 2B and FIG. 2C, there are two first lamps L1 and L2 disposed at a first section A1. On the other hand, there are five second lamps L3, L4, L5, L6, L7 and L8 disposed at a second section A2, and there are two third lamps L9 and L10 disposed at a third section A3. It needs to notice that, this embodiment can be implemented by disposing at least one lamp at the first section A1 and the second section A2 respectively, and this embodiment is not limited by the example shown in FIG. 2B and FIG. 2C. Similarity, the first range may indicate the battery power from 0% to 20%, the first range may indicate the battery power from 20% to 80%, and the third range may indicate the battery power from 80% to 100%. When the controller 13 determines that the battery power value is 10% in the trigger period, the controller 13 controls the first lamp L1 to generate the light having the second optical characteristic based on the ration between the current battery power and the maximum battery power. When the controller 13 determines that the battery power value is 50% in the trigger period, the controller 13 controls each of the first lamps L1 and L2 to generate the light having the second optical characteristic, and the controller 13 controls the second lamps L3, L4 and L5 to generate the light having the third optical characteristic based on the ration between the current battery power and the maximum battery power. Therefore, as the battery power of the battery assembly 11 is increasing, the controller 13 is able to control the second lamps L6, L7 and L8 to generate the light having the third optical characteristic in sequence, and control the third lamps L9 and L10 to generate the light with the optical characteristic different from the second and the third optical characteristic different light in sequence.

For these reasons, when the battery power value is in the first range but has not reached the first range, at least one of the first lamps L1 and L2 is able to generate the light having the second optical characteristic in the trigger period. Also, when the battery power value is in the first range but has not reached the third range, each of the first lamps L1 and L2 is able to generate the light having the second optical characteristic in the trigger period, and at least one of the second lamps L3, L4, L5, L6, L7 and L8 generates the light having the third optical characteristic. In an embodiment, the second optical characteristic and the third optical characteristic have different colors (such as red light and yellow light, or the red light with different brightness or darkness levels), but other embodiment is not limited thereto.

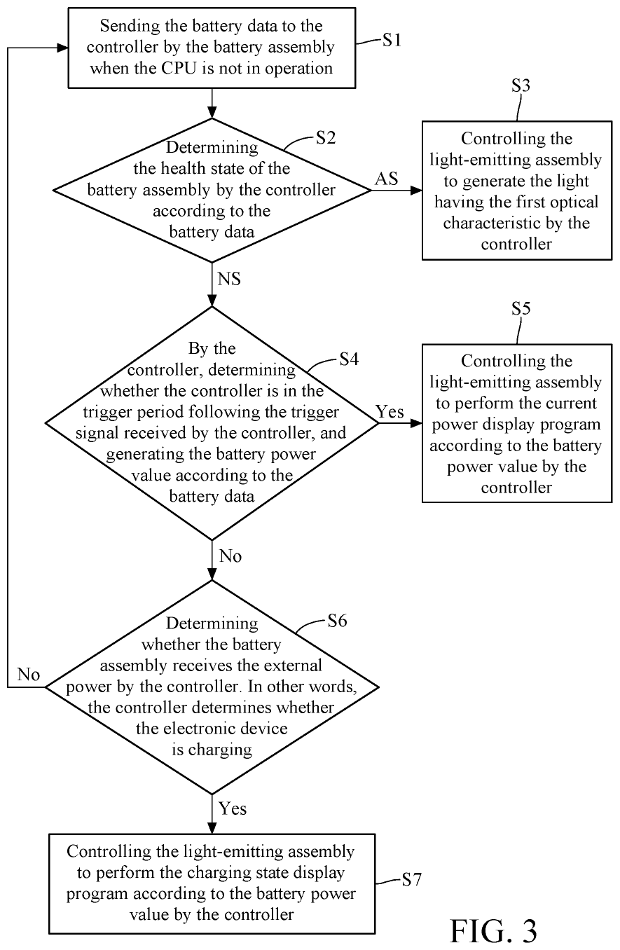

Please refer to FIG. 3. FIG. 3 is the flowchart of the method for displaying battery state in an embodiment of this disclosure. Please refer to step S1: sending the battery data to the controller by the battery assembly when the CPU is not in operation; wherein the battery data is the original data generated by the battery assembly. Please refer to step S2: determining the health state of the battery assembly by the controller according to the battery data; wherein the health state is associated with the battery life of the battery assembly.

When the controller determines that the health state is in the abnormal state AS, please refer to step S3: controlling the light-emitting assembly to generate the light having the first optical characteristic by the controller. In an embodiment, the first optical characteristic and the second optical characteristic have different flashing frequencies in order to classify whether the state of the battery assembly is the low battery power state or the abnormal state AS. On the other hand, when the controller determines that the health state is in the normal state NS, please refer to step S4: by the controller, determining whether the controller is in the trigger period following the trigger signal received by the controller, and generating the battery power value according to the battery data; wherein the battery power value is associated with the current battery power of the battery assembly. Specifically, the battery assembly may have a current maximum battery power value and a default battery power value, and the controller determines whether a ratio between the current maximum battery power value and the default battery power value is in an abnormal range. When the ratio is outside the abnormal range, and the controller determines that the health state is in the normal state NS. Conversely, when the ratio is inside the abnormal range, the controller determines that the health state is in the abnormal state AS.

Particularly, the controller is able to determine whether the ratio is in the abnormal range by a threshold. For example, the threshold is 50%, when the ratio is larger than 50%, the state of the battery assembly is in the normal state NS. On the other hand, when the ratio is not larger than 50% (comprising equaling to 50%), the state of the battery assembly is in the abnormal state AS. In addition, the boundary condition for classifying the abnormal range and the normal range is able to be defined differently from the example hereinbefore. For example, the ratio less than 50% (threshold) is able to indicate the abnormal state AS, and the ratio larger than/equal to 50% (threshold) is able to indicate the normal state NS. It needs to notice that, the expired date of the battery assembly is different from the brands or the kinds of the battery assembly in practice, so aforementioned 50% is just an example for descripting the details more clearly rather than limiting this embodiment. On the other hand, the controller is also able to determine whether the health state is in the abnormal state based on other conditions such as charge rate, discharge rate and abnormal powered off, etc., and this disclosure is not limited thereto.

When the controller is in the trigger period, please refer to step S5: controlling the light-emitting assembly to perform the current power display program according to the battery power value by the controller; wherein the current power display program indicates the light-emitting assembly generating light for displaying the battery power value during the trigger period. When the controller is outside the trigger period, please refer to step S6: determining whether the battery assembly receives the external power by the controller. In other words, the controller determines whether the electronic device E is charging. When the controller determines that the battery assembly receives the external power, please refer to step S7: controlling the light-emitting assembly to perform the charging state display program according to the battery power value by the controller; wherein the charging state display program indicates that the light-emitting assembly displays the current state of charge via the light with corresponding optical characteristic.

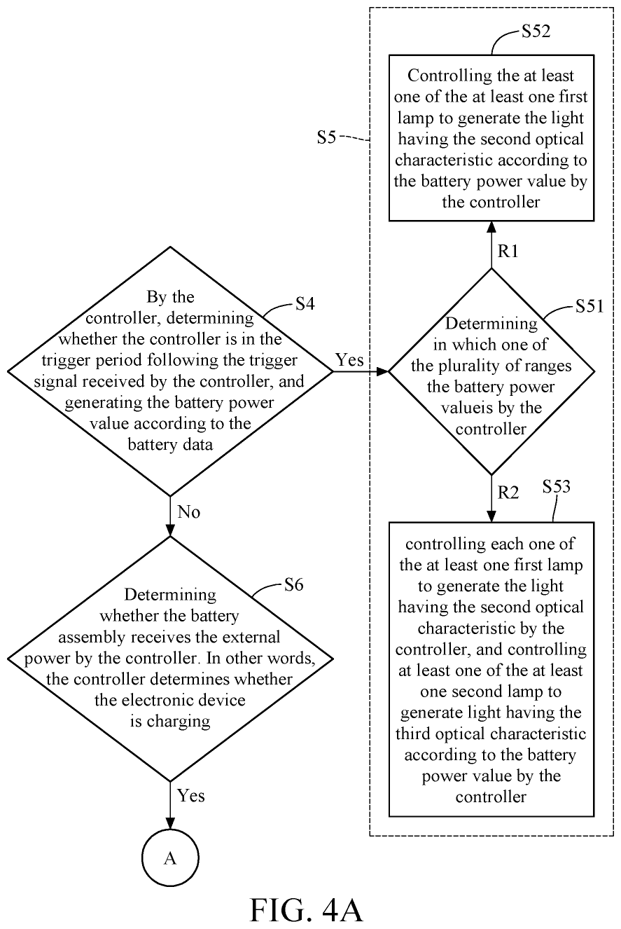

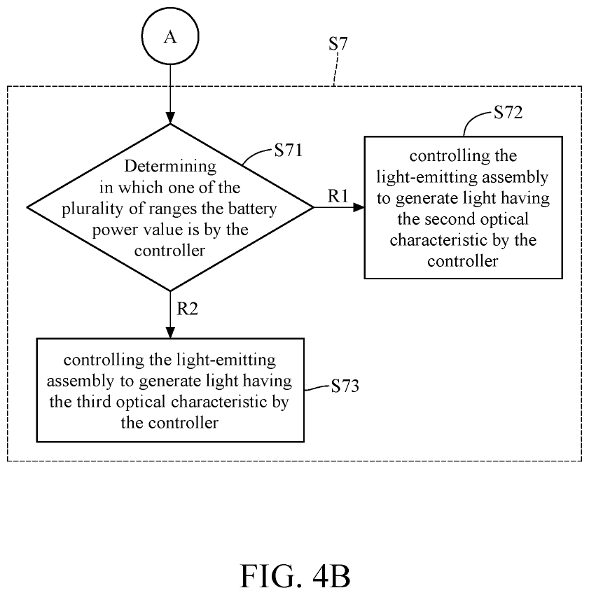

Please refer to FIG. 4A. FIG. 4A is the detailed flowchart of the steps S5 in the FIG. 3. Please refer to step S51 to S53 in order to describe the current power display program. Please refer to step S51: determining in which one of the plurality of ranges the battery power value is by the controller; wherein the number of the plurality of ranges is at least two (for example, the first range R1 and the first range R2 mentioned hereinbefore). Also, the number of the plurality of ranges is able to be three or more. When the controller determines that the battery power value is in the first range R1 of aforementioned ranges, please refer to step S52: controlling the at least one of the at least one first lamp to generate the light having the second optical characteristic according to the battery power value by the controller; wherein the second optical characteristic is adapted to display the battery power value in the first range R1. When the controller determines that the battery power value is in the first range R2 of aforementioned ranges, please refer to step S53: controlling each one of the at least one first lamp to generate the light having the second optical characteristic by the controller, and controlling at least one of the at least one second lamp to generate light having the third optical characteristic according to the battery power value by the controller. Briefly, the third optical characteristic is adapted to display the battery power value of the first range R2, and the third optical characteristic may have the color or flashing frequency different from the second optical characteristic.

Please refer to FIG. 4B. FIG. 4B is the detailed flowchart of the steps S7 in the FIG. 3. Please refer to steps S71 to S73 for describing the charging state display program. Since the step S71 is the same as S51, the description is omitted herein. When the controller determines that the battery power value is in the first range R1 of the plurality of ranges, please refer to step S72: controlling the light-emitting assembly to generate light having the second optical characteristic by the controller. On the other hand, when the controller determines that the battery power value is in the first range R2 of the plurality of ranges, please refer to step S73: controlling the light-emitting assembly to generate light having the third optical characteristic by the controller. Particularly, when the controller controls the light-emitting assembly to perform the charging state display program, each of the lamps of the light-emitting assembly is able to generate light, wherein the light is able to display different states of charge through different optical characteristics.

As a result, this disclosure is to provide the device and method for displaying battery state, wherein the device and method is adapted to an electronic device. Even when the operating system (OS) of the electronic device is not active, the device and method are still able to generate the light with different optical characteristics through the light-emitting assembly of the electronic device in order to display the information of the battery assembly such as the current battery power, the state of charge and the health state. Hence, the user is able to check the information of the battery assembly of electronic device quickly and preciously even when the electronic device does not enter the OS.

The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A method for displaying battery state adapted to an electronic device having a central processing unit, comprising:
sending a battery data to a controller by a battery assembly when the central processing unit is not in operation;
determining a health state of the battery assembly by the controller according to the battery data;
controlling a light-emitting assembly to generate light having a first optical characteristic by the controller when the controller determines that the health state is in an abnormal state;
by the controller, determining whether the controller is in a trigger period following a trigger signal received by the controller and generating a battery power value according to the battery data when the controller determines that the health state is in a normal state;
controlling the light-emitting assembly to perform a current power display program according to the battery power value by the controller when the controller is in the trigger period;
determining whether the battery assembly receives an external power by the controller when the controller is outside the trigger period; and
controlling the light-emitting assembly to perform a charging state display program according to the battery power value by the controller when the controller determines that the battery assembly receives the external power.

2. The method for displaying battery state according to claim 1, wherein controlling the light-emitting assembly to perform the charging state display program according to the battery power value by the controller comprises:
determining in which one of a plurality of ranges the battery power value is by the controller;
controlling the light-emitting assembly to generate light having a second optical characteristic by the controller when the controller determines that the battery power value is in a first range of the plurality of ranges; and
controlling the light-emitting assembly to generate light having a third optical characteristic by the controller when the controller determines that the battery power value is in a second range of the plurality of ranges.

3. The method for displaying battery state according to claim 1, wherein the light-emitting assembly comprises at least one first lamp disposed in a first section and at least one second lamp disposed in a second section, wherein controlling the light-emitting assembly to perform a current power display program according to the battery power value by the controller when the controller is in the trigger period comprises:
determining in which one of a plurality of ranges the battery power value is by the controller;
controlling at least one of the at least one first lamp to generate light having a second optical characteristic according to the battery power value by the controller when the controller determines that the battery power value is in a first range of the plurality of ranges; and
controlling each one of the at least one first lamp to generate the light having the second optical characteristic by the controller, and controlling at least one of the at least one second lamp to generate light having a third optical characteristic according to the battery power value by the controller when the controller determines that the battery power value is in a second range of the plurality of ranges.

4. The method for displaying battery state according to claim 2, wherein the second optical characteristic and the third optical characteristic have different colors.

5. The method for displaying battery state according to claim 3, wherein a second optical characteristic and the third optical characteristic have different colors.

6. The method for displaying battery state according to claim 1, wherein the battery assembly has a current maximum battery power value and a default battery power value, and determining the health state of the battery assembly by the controller according to the battery data comprises:
determining whether a ratio between the current maximum battery power value and the default battery power value is in an abnormal range by the controller;
determining that the health state is in the normal state by the controller when the ratio is outside the abnormal range; and
determining that the health state is in the abnormal state by the controller when the ratio is inside the abnormal range.

7. The method for displaying battery state according to claim 5, wherein the first optical characteristic and the second optical characteristic have different flashing frequencies.

8. A device for displaying battery state adapted to an electronic device having a central processing unit, comprising:
a battery assembly generating battery data when the central processing unit is not in operation;
a light-emitting assembly adapted to generate a light having a first optical characteristic in a trigger period, and the light-emitting assembly performing a current power display program when the battery assembly receives an external power; and
a controller electrically connected between the battery assembly and the light-emitting assembly, with the controller receiving the battery data and determining a health state of the battery assembly according to the battery data, wherein the controller controls the light-emitting assembly to generate light having the first optical characteristic when the controller determines that the health state is in an abnormal state, and the controller determining whether the controller is in a trigger period following a trigger signal received by the controller when the controller determines that the health state is in a normal state, and the controller generates a battery power value according to the battery data, wherein the controller controls the light-emitting assembly to perform the current power display program according to the battery power value in the trigger period, and the controller determines whether the battery assembly receives the external power when the controller is outside the trigger period, wherein the controller controls the light-emitting assembly to perform a charging state display program according to the battery power value when the controller the battery assembly receives the external power.

9. The device for displaying battery state according to claim 8, wherein the light-emitting assembly comprises at least one first lamp disposed in a first section and at least one second lamp disposed in a second section, and at least one of the at least one first lamp generates light having a second optical characteristic according to the battery power value when the controller determines the battery power value is in a first range, and each of the at least one first lamp generates light having the second optical characteristic when the controller determines that the battery power value is in a second range, and at least one of the at least one second lamp generate light having a third optical characteristic according to the battery power value when the controller determines that the battery power value is in the second range.

10. The device for displaying battery state according to claim 9, wherein the second optical characteristic and the third optical characteristic have different colors.

11. The device for displaying battery state according to claim 8, wherein the light-emitting assembly is disposed on a surface of the electronic device, and the surface is exposed when a screen of the electronic device is concealed.
